(19) United States
(12) Patent Application Publication
(10) Pub. No.: US 2025/0307494 A1
(43) Pub. Date: Oct. 2, 2025

(54) SENSOR ROLLER DATA MEASUREMENT LOAD CASES

(71) Applicant: AKTIEBOLAGET SKF, GOTEBORG (SE)

(72) Inventors: Mats PERSSON, Amstelveen (NL); Pietro TESINI, Utrecht (NL); Jonas KRISTENSEN, Viborg (DK); Andreas Clemens VAN DER HAM, Warnsveld (NL)

(21) Appl. No.: 19/083,700

(22) Filed: Mar. 19, 2025

(30) Foreign Application Priority Data
Mar. 27, 2024 (DE) 102024202895.9

(51) Int. Cl. G06F 30/20; G01M 13/04

(52) U.S. Cl. CPC G06F 30/20; G01M 13/04

(57) ABSTRACT

A method for estimating an accuracy of a simulation model of a machine having a rolling-element bearing includes determining sets of machine operating measurements and sets of bearing operating measurements at certain reference moments, determining values of a bearing indicator from the sets of bearing operating measurements and determining values of the bearing indicator from the simulation model of the machine, comparing the values of the measured bearing indicator and the simulated bearing indicator for identical values of the operating parameter of the machine, and estimating an accuracy of the simulation model of the machine from the comparison. Also a device for performing the method.

### CROSS-REFERENCE

This application claims priority to German patent application no. 10 2024 202 895.9 filed on Mar. 27, 2024, the contents of which are fully incorporated herein by reference.

### TECHNOLOGICAL FIELD

The present disclosure is directed to a comparison of outputs generated by simulation models of machines comprising a bearing and data measured on the machines, and more particularly to a method and device for estimating the accuracy a simulation model of a machine comprising a rolling-element bearing.

### BACKGROUND

It is known to implement simulation models of machines in order to design machines. The machine may be a wind turbine comprising at least one bearing. Design load cases comprising for example external loads, are applied on the simulation of the wind turbine to validate the design of the wind turbine. By running the simulation model, bearing response output results, such as bearing loads, roller loads and life rating may be generated to verify the design of the bearing.

The quality of the bearing response output results depends on the accuracy of the outputs of the simulation model as compared to the outputs that would be measured on the wind turbine for the same loading conditions. It is necessary to determine how well the simulation model represents the behavior of the wind turbine, especially the behavior of the bearing, to determine for example the bearing loads, roller loads and life rating.

### SUMMARY

It is therefore an aspect of the present disclosure to provide a method and apparatus to estimate the accuracy of a simulation model of a machine comprising a rolling-element bearing. According to a further aspect, a method for estimating the accuracy of a simulation model of a machine comprising a rolling-element bearing is also provided.

The rolling-element bearing comprises a stationary ring and a rotatable ring configured to rotate concentrically relative to one another, and at least one row of rolling elements interposed between a first raceway and a second raceway respectively provided on the first and second rings wherein at least one of the rolling elements is a sensorized rolling element.

The method comprises: determining sets of machine operating measurements representative of an operation of the machine, each set of machine operating measurements being associated with a first reference moment and comprising a value of at least an operating parameter of the machine, determining sets of bearing operating measurements representative of the operation of a bearing in the machine from measurements delivered by the sensorized rolling element of the rolling-element bearing, each set of bearing operating measurements being associated with a second reference moment, determining sets of measurements, each set comprising a set of machine operating measurements and a set of bearing operating measurements wherein the first reference moment of the set of machine operating measurements is equal to the second reference moment of the set of bearing operating measurements, determining values of at least one bearing indicator from the sets of bearing operating measurements according to the values of the operating parameter of the machine, the bearing indicator being a measured bearing indicator, determining values of the bearing indicator from the simulation model of the machine and sets of machine operating measurements according to the values of the operating parameter of the machine, the bearing indicator being a simulated bearing indicator, comparing the values of the measured bearing indicator and the simulated bearing indicator for identical values of the operating parameter of the machine, and estimating an accuracy of the simulation model of the machine from the comparison.

The method allows an accuracy of the simulation model of the machine to be determined by comparing values of the simulated bearing indicator determined from the operating parameter of the machine measured on the machine and the measured bearing indicator measured directly on the machine.

The first reference moment and the second reference moment may be time stamp values.

When the simulation model is accurate enough, the simulation model is validated for further uses, for example to perform root cause analysis and/or optimization, and design new machines.

Advantageously, determining the measured bearing indicator comprises: binning the sets of measurements in a predetermined number of bins according to the values of the operating parameter of the machine, and for each bin, determining a value of the bearing indicator from the sets of bearing operating measurements of the bin, the values of the measured bearing indicator being the values of the bearing indicator.

Preferably, the method further comprises determining a first continuous function from the values of the bearing indicator of different bins, the measured bearing indicator being the first continuous function.

Advantageously, determining the simulated bearing indicator comprises for each bin, implementing the simulation model at least twice, wherein for each implementation of the simulation model, the inputs of the simulation model are machine operating measurements of a set of machine operating measurements, and determining for each implementation of the simulation model at least a value of the bearing indicator from the output of the implementation of the simulation model, the values of the bearing indicator being the values of the simulated bearing indicator.

Preferably, comparing the values of the measured bearing indicator and the simulated bearing indicator and estimating the accuracy of the simulation model comprises: determining a relative gap value (relative difference) between the values of the measured bearing indicator and the simulated bearing indicator for each value of the operating parameter of the machine and determining a reference value from the plurality of relative gap values, wherein the accuracy of the simulation model is equal to the reference value. Advantageously, the simulation model may be considered to be accurate enough if the reference value is less than a threshold.

According to another aspect, a device for estimating the accuracy of a simulation model of a machine comprising a rolling-element bearing is disclosed.

The rolling-element bearing comprises a stationary ring and a rotatable ring configured to rotate concentrically relative to one another, and at least one row of rolling elements interposed between a first raceway and a second raceway respectively provided on the first and second rings, at least one of the rolling elements being a sensorized rolling element.

The device comprises: first determining means configured to determine sets of machine operating measurements representative of the operation of the machine, and associating a first reference moment with each set of machine operating measurements, each set of machine operating measurements comprising a value of at least an operating parameter of the machine. The device also includes the sensorized rolling element of the rolling-element bearing that is configured to deliver measurements, and second determining means configured to determine sets of bearing operating measurements representative of the operation of the bearing in the machine from measurements delivered by the sensorized rolling element and to associate each set of bearing operating measurements to a second reference moment. The device also includes third determining means configured to determine sets of measurements, each set of measurement comprising a set of machine operating measurements and a set of bearing operating measurements wherein the first reference moment of the set of machine operating measurements is equal to the second reference moment of the set of bearing operating measurements, fourth determining means configured to determine values of at least one bearing indicator from the sets of bearing operating measurements according to the values of the operating parameter of the machine, the bearing indicator being a measured bearing indicator, and fifth determining means configured to determine values of the bearing indicator from the simulation model of the machine and sets of machine operating measurements according to values of the operating parameter of the machine, the bearing indicator being a simulated bearing indicator. The device also includes comparing means configured to compare the values of the measured bearing indicator and the simulated bearing indicator for identical values of the operating parameter of the machine and to estimate the accuracy of the simulation model of the machine from the comparison.

Preferably, the sensorized rolling element comprises a load sensor, a position sensor and/or a speed sensor.

According to another aspect, a system for estimating the accuracy of a simulation model of a machine comprising a rolling-element bearing is disclosed. The system comprises: a device as defined above, a machine comprising a rolling-element bearing, the rolling-element bearing comprising a stationary ring and a rotatable ring configured to rotate concentrically relative to one another, and at least one row of rolling elements interposed between a first raceway and a second raceway respectively provided on the first and second rings, and a simulation model of the machine. Preferably, the machine is a wind turbine.

### BRIEF DESCRIPTION OF THE DRAWINGS

Other advantages and features of the disclosure will appear on examination of the detailed description of embodiments, in no way restrictive, and the appended drawings in which:

FIG. 1 is a schematic illustration of an example of a machine according to an embodiment of the present disclosure.

FIG. 2 is a schematic illustration of a rolling-element bearing according to an embodiment of the disclosure.

FIG. 3 is a schematic illustration of a sensorized rolling element according to an embodiment of the disclosure.

FIG. 4 is a schematic illustration of a processing module according to an embodiment of the disclosure.

FIG. 5 is a flowchart schematically illustrating an example of a method for estimating an accuracy of a simulation model according to an embodiment of the disclosure.

FIG. 6 is a graph schematically illustrating examples of the measured bearing indicator and an example of the simulated bearing indicator according to an embodiment of the disclosure.

### DETAILED DESCRIPTION

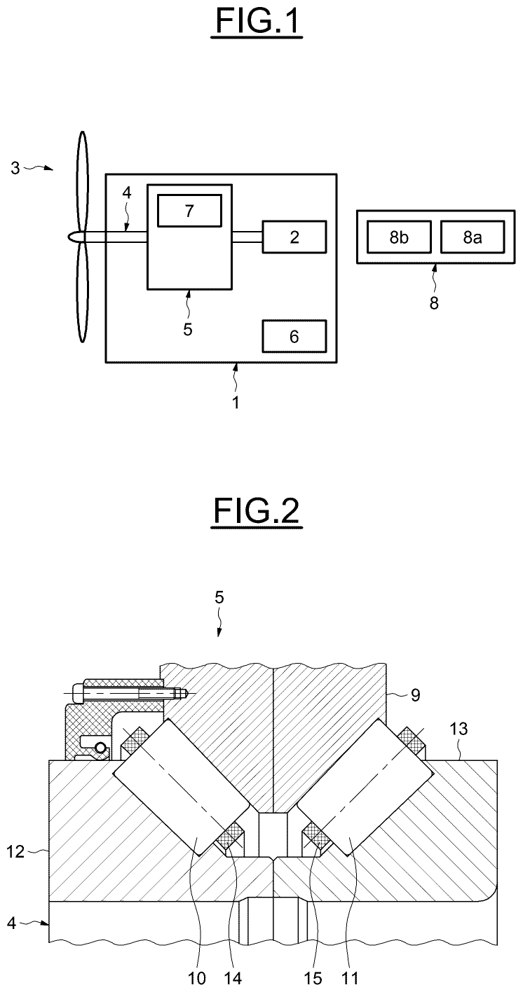

Reference is made to FIG. 1 which represents schematically an example of a machine 1 comprising a rolling-element bearing 5. The machine 1 may be a wind turbine comprising a generator 2, a blade rotor 3, a shaft 4 connecting a shaft of the generator 2 to the blade rotor 3, and a rolling-element bearing 5 supporting the shaft 4. In other embodiments, the machine 1 may be a tunnel boring machine, a mining extraction machine or a big offshore crane.

The machine 1 may further comprise a sensor 6 to measure values of an operating parameter of the machine which values are representative of the condition of use of the machine 1. The operating parameter of the machine representative of the condition of use of the machine may be for example the wind speed, the speed of the shaft 4, the temperature of the machine, the power generated by the wind turbine 1, the torque on the shaft 4.

The rolling-element bearing 5 also includes at least one sensorized rolling element 7.

In a non-represented variant, the wind turbine further comprises a gearbox connecting the shaft of the generator 2 to the shaft 4 of the wind turbine. A rolling-element bearing of the gearbox may comprise the sensorized rolling element 7. An example of the rolling-element bearing 5 is detailed in the following.

The sensor 6 and the sensorized rolling element 7 communicate with a processing module 8. The processing module may include a programmable hardware component such as a processor, a computer processor (CPU=central processing unit), an application-specific integrated circuit (ASIC), an integrated circuit (IC), a computer, a system-on-a-chip (SOC), a programmable logic element, or a field programmable gate array (FGPA) including a microprocessor.

The processing module 8 includes a simulation model 8a of the wind turbine 1 and a device 8b for estimating the accuracy of the simulation model 8a. The device 8b comprises the sensorized rolling element 7. The sensor 6 may communicate with the processing module 8 through a wire connection or a wireless connection. The sensorized rolling element 7 communicates wirelessly with the processing module 8.

An example of the processing module 8 is detailed in the following.

FIG. 2 illustrates schematically an example of the rolling-element bearing 5.

The bearing 5 comprises an outer ring or stationary ring 9 having conically shaped first and second outer raceways for a first row 10 and a second row 11 of rolling elements, the rolling elements comprising tapered rollers. The bearing further comprises a rotatable ring provided with first and second inner rings or rotatable rings 12, 13 axially stacked and which are respectively provided with conically shaped first and second inner raceways for the first and second roller rows 10, 11. In addition, the bearing 5 further comprises a first cage 14 and a second cage 15 for retaining the rollers of the first and second roller sets respectively. Typically, the cages may be formed from segments that abut each other in circumferential direction.

To provide the necessary stiffness and ensure a long service life, the bearing is preloaded. The axial position of the rotatable rings 12, 13 relatives to the stationary ring 9 is set such that the first and second roller sets 9, 11 have a negative internal clearance. In variant, the bearing is not preloaded.

In the depicted bearing, at least one of the rolling elements in either of the first and second roller rows 10, 11 is replaced with the sensorized rolling element 7. The shaft 4 is surrounded and fixed to the rotatable rings 12, 13.

The rolling-element bearing 5 comprises tapered rollers. In another embodiment, the rolling-element bearing 5 may comprise other type of rolling elements, for example cylindrical rollers or spherical rollers. The rolling-element bearing 5 may also comprise only one row of rolling elements or more than two rows of rolling elements, the number of cage being determined according to the number of row.

The rolling-element bearing 5 comprising a row of rolling elements comprises a unique inner ring. In another embodiment, the outer ring 9 is the rotatable ring and the inner rings 12, 13 are the stationary rings.

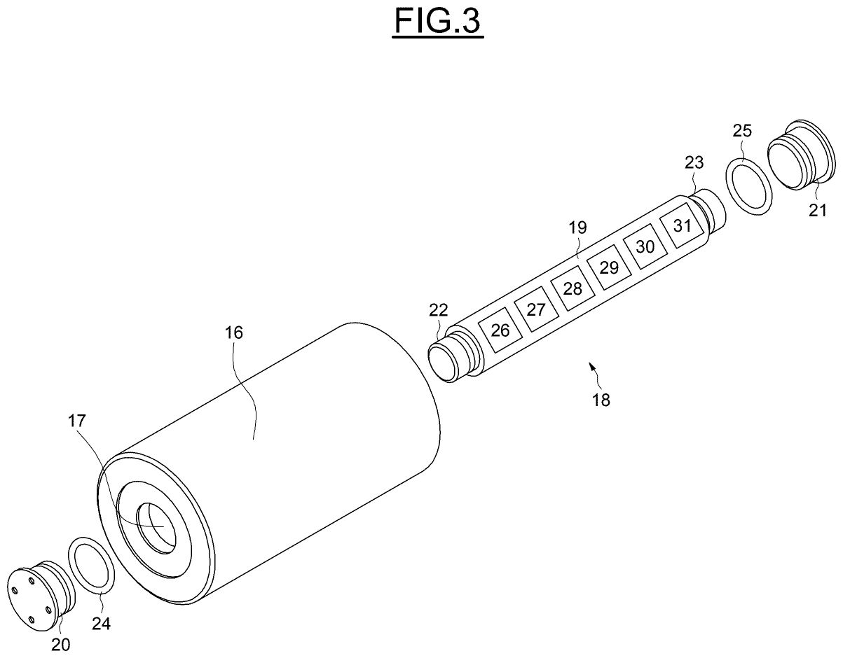

FIG. 3 illustrates schematically an example of the sensorized rolling element 7.

The sensorized rolling element 7 comprises a roller body 16 comprising a central bore 17, and a sensor unit 18 within the central bore 17 that extends through the roller body 16. The sensor unit 18 comprises a housing 19 formed from two semi-cylindrical housings which are fixed together by first and second end caps 20, 21 that screw onto corresponding first and second threaded portions 22, 23 at opposite axial ends of the housing. The sensor unit housing as a whole is shaped to fit within the roller bore 17, and is mounted to and located in the bore 17 by way of first and second sealing elements 24, 25.

The sensor unit 18 further comprises a load sensor 26 for measuring the load distribution across the sensorized rolling element 7. The load distribution comprises load values.

The sensor unit 18 may further comprise a speed sensor 27 for measuring the rotational speed of the sensorized rolling element 7 in the bearing 5 and may further comprise a position sensor 28 for measuring the sensorized rolling element azimuth (position of the sensorized rolling element around the circumference of the rings 9, 12, 13) of the sensorized rolling element 7.

The sensor unit 18 comprises a wireless transmitter 29 to transmit sets of measurements of the sensors 26, 27, 28, a sampler 30 to sample signals delivered by the sensors, and a battery 31 supplying the sensors 26, 27, 28 and the wireless transmitter.

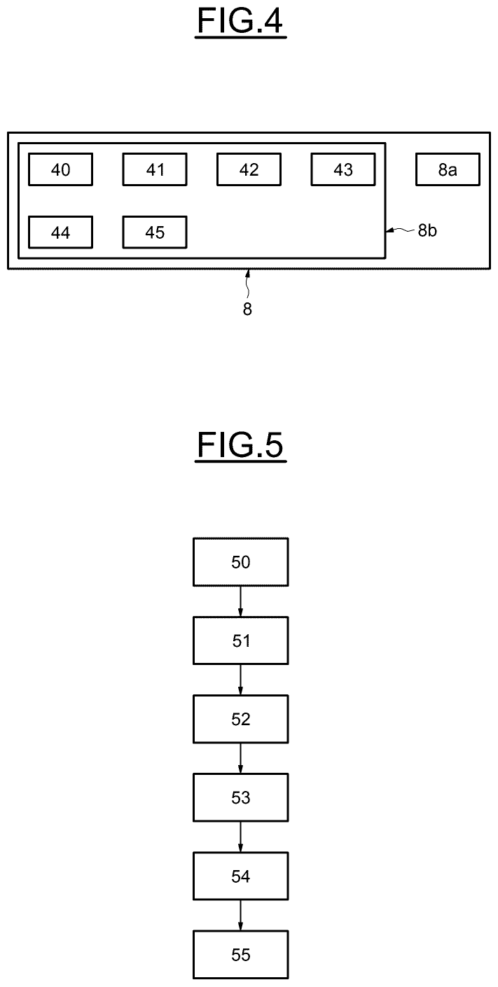

FIG. 4 illustrates schematically an example of the processing module 8. The processing module 8 comprises the simulation model 8a and the device 8b.

The device 8b further comprises first determining means 40 for determining sets of machine operating measurements representative of the operation of the machine and for associating a first reference moment with each set of machine operating measurements. Each set of machine operating measurements comprises a value of the operating parameter of the machine 1 measured by the sensor 6. Each of the determining means and comparing means discussed herein may may include a programmable hardware component such as a processor, a computer processor (CPU=central processing unit), an application-specific integrated circuit (ASIC), an integrated circuit (IC), a computer, a system-on-a-chip (SOC), a programmable logic element, or a field programmable gate array (FGPA) including a microprocessor.

The device 8b comprises second determining means 41 for determining sets of bearing operating measurements representative of the operation of the bearing 5 in the wind turbine 1 from measurements delivered by the sensorized rolling element 7 and associating each set of bearing operating measurements with a second reference moment. The first reference moment and the second reference moment may be time stamp values. Each set of bearing operating measurements may comprise load values, the sensorized rolling element azimuth and the rotational speed of the sensorized rolling element 7.

The device 8b further comprises third determining means 42 for determining sets of measurements. Each set of measurement comprising a set of machine operating measurements and a set of bearing operating measurements. The first reference moment of the set of machine operating measurements is equal to the second reference moment of the set of bearing operating measurements.

The sampling frequency of the measurements delivered by the sensorized rolling element 7 and the sampling frequency of the values of the operating parameter of the machine 1 measured by the sensor 6 may be different. The third determining means 42 may be configured to interpolate the measurements delivered by the sensorized rolling element 7 or the values of the operating parameter measured by the sensor 6 so that the second reference moment of the measurements and the first reference moment of the values of the operating parameter are the same.

The device 8b comprises fourth determining means 43 for determining values of at least one bearing indicator from the sets of bearing operating measurements according to the values of the operating parameter of the machine. The bearing indicator may be for example the basic rating life L10 defined in ISO 281, the modified rating life Lₙₘ defined in ISO 281, the modified reference rating life Lₙₘᵣ defined in ISO/TS 16281, contact misalignments of the sensorized rolling element 7, load zone plots of the bearing 5, lateral contact length of the sensorized rolling element 7 or pressure distribution in the contact of the sensorized rolling element 7 with the rings 9, 12, 13. The bearing indicator determined by the fourth determining means 43 is a measured bearing indicator.

The device 8b further comprises fifth determining means 44 for determining values of the bearing indicator from the simulation model 8a and the sets of machine operating measurements according to the values of the operating parameter of the wind turbine. The fifth determining means 44 are configured to implement the simulation model 8a. The bearing indicator determined from the simulation model 8a is the simulated bearing indicator.

The device 8b comprises comparing means 45 for comparing the values of the measured bearing indicator and the simulated bearing indicator for identical values of the operating parameter of the machine and for estimating the accuracy of the simulation model 8a from the comparison.

The device 8b comprising the sensorized rolling element 7, simulation model 8a and the machine 1 form a system for estimating the accuracy of the simulation model 8a.

FIG. 5 illustrates schematically an example of a method for estimating the accuracy of a simulation model. The method implements the system for estimating the accuracy of the simulation model 8a.

During a step 50, the first determining means 40 determines the sets of machine operating measurements representative of the operation of the machine and associates a first reference moment (reference time) with each set of machine operating measurements. It is assumed that the operating parameter comprises the wind speed of the wind driving the blade rotor 3.

During a step 51, the second determining means 41 determines the sets of bearing operating measurements from measurements delivered by a sensorized rolling element 7 and associates a second reference moment with each set of bearing operating measurements. It is assumed that each set of bearing operating measurements comprises load values measured by the load sensor 26 and sensorized rolling element azimuth values measured by the position sensor 28.

During a step 52, the third determining means 42 determine the sets of measurements.

During a step 53, the fourth determining means 43 determine the values of the measured bearing indicator. The fourth determining means 43 bins the sets of measurements in a predetermined number of bins according to the values of the operating parameter of the machine. For each bin, the fourth determining means 43 determines a value of the bearing indicator from the sets of bearing operating measurements of the bin. The values of the measured bearing indicator are the values of the bearing indicator.

The predetermined number of bins is determined so that the measurements included in each bin is enough to determine the measured bearing indicator of the bin and to eliminate measurements which are not consistent with the other measurements in the bin or that might have resulted from some measurement glitch.

The fourth determining means 43 may implement k-means clustering to bin the sets of measurements. The fourth determining means 43 may further determine a first continuous function from the values of the bearing indicator of different bins for example by interpolating the values of the bearing indicator between different bins. The measured bearing indicator is the first continuous function. It is assumed that the measured bearing indicator is the load applied on the sensorized rolling element 7 depending on the azimuth of the sensorized rolling element 7 according to the wind speed.

The sets of measurements are regrouped in a plurality of bins Bᵢ, i being an integer between 0 and N, N being the predetermined number of bins Bᵢ. Each bin Bᵢ has a lower bound Vᵢ and an upper bound Vᵢ₊₁. The measurements of each set of measurement having a wind speed included between Vᵢ and Vᵢ₊₁ are regrouped in the bin Bᵢ.

During a step 54, the fifth determining means 44 implements the simulation model 8a to determine values of the bearing indicator. The fifth determining means 44 determines values of the bearing indicator from the simulation model 8a and sets of machine operating measurements according to the values of the operating parameter of the machine. The bearing indicator determined by the fifth determining means 44 is the simulated bearing indicator.

The fifth determining means 44 determine values of the simulated bearing indicator for each bin Bᵢ. For each bin Bᵢ, the fifth determining means 54 implement the simulation model 8a at least two times. For each implementation of the simulation model 8a, the inputs of the simulation model are machine operating measurements of a set of machine operating measurements. The sets inputted for the two implementations of the simulation model 8a are different.

For example, the inputs for a first implementation of the simulation model 8a of the bin Bi comprise a first set of machine operating measurements associated with the value Vᵢ of the operating parameter, and the inputs for the second implementation of the simulation model 8a of the bin Bi comprise a second set of machine operating measurements associated with the value Vᵢ₊₁ of the operating parameter.

The fifth determining means 44 may further determine a second continuous function from the values of the simulated bearing indicator between different bins, for example by interpolating the values of the simulated bearing indicator between different bins. The simulated bearing indicator is the second continuous function.

During a step 55, the comparing means 45 compare the values of the measured bearing indicator and the simulated bearing indicator for identical values of the operating parameter of the machine and estimate the accuracy of the simulation model of the machine from the comparison. The comparing means 45 determine a relative gap value between the values of the measured bearing indicator and the simulated bearing indicator for each value of the operating parameter of the machine. The comparing means 45 determine a reference value from the plurality of relative gap values. The accuracy of the simulation model is equal to the reference value. The simulation model is accurate enough if the reference value is less than a threshold.

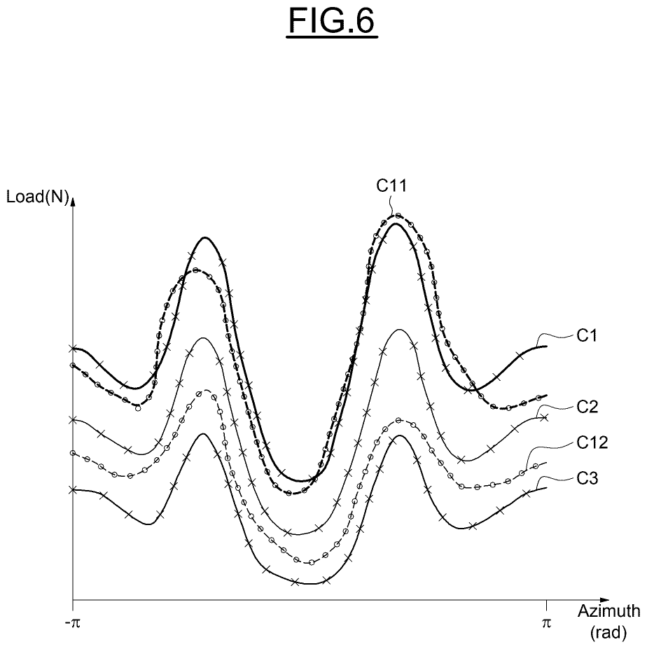

FIG. 6 illustrates schematically an example of the measured bearing indicator and an example of the simulated bearing indicator.

The curves C1, C2, C3 represent the simulated bearing indicator comprising the load applied on the sensorized rolling element 7 according to the azimuth in the interval [−π; π] of the sensorized rolling element 7 for the operating parameter of the machine comprising for example the wind speed included between Vⱼ and Vⱼ₊₁ regrouped in the bin Bⱼ, j being a value between 0 and M. The curve C1 represents the simulated bearing indicator determined from the simulation model and sets of machine operating measurements associated with the wind speed value Vⱼ₊₁. The curve C2 represents is the simulated bearing indicator determined form the simulation model and sets of machine operating measurements associated with the wind speed value (Vⱼ₊₁+Vⱼ)/2. The curve C3 represents is the simulated bearing indicator determined form the simulation model and sets of machine operating measurements associated with the wind speed value Vⱼ.

The determined values determined (crosses on FIG. 6) from the simulation model of the simulated bearing indicator are interpolated to determine the curves C1, C2, C3. The curves C11 and C12 represent the measured bearing indicator for the wind speed included between Vⱼ and Vⱼ₊₁.

In another embodiments, the operating parameter of the machine may comprise the speed of the shaft 4, the temperature of the machine, the power generated by the wind turbine 1 or the torque on the shaft 4.

When the simulation model is accurate enough, the simulation model is used to perform root cause analysis.

When deviations/discrepancy between for example a simulated bearing indicator and the associated measured bearing indicator are observed, the deviations are an indication that the machine is deviating from the intended design. The simulation model may be used to study the possible combinations of design parameters of the machine which are at the origin of the deviations. The configurations of design parameters of the machine that are at the origin of the deviations may therefore being identified. For example, unexpected deformations of bearing rings (due to mounting, tolerances of supporting structures, etc.) or excessive misalignment of bearing rings. The results of such an analysis may as well be combined with findings originating from a bearing analysis of the same machine type. Diagnostic comparison over time may also done.

The simulation model may be also implemented with a fixed load set representative of beginning failures and the bearing indicator determined form of the implementation of the simulation model may be compared with the bearing indicator determined from the measurements to identify beginning of failures for long term monitoring of the bearing.

The accurate simulation model may be implemented to optimize the design and/or the control of the machine, for example maximizing power output of the wind turbine. The presented method allows to determine to accuracy of the simulation model of the machine compared to measurements delivered by the sensorized rolling element 7 and the sensor 6. When the simulation model is accurate enough, the simulation model is validated for further uses, for example to perform root cause analysis and/or optimization, and design new machines.

Representative, non-limiting examples of the present invention were described above in detail with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provide improved rolling element bearing modeling.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

What is claimed is:

1. A method for estimating an accuracy of a simulation model of a machine, the machine comprising a rolling-element bearing, the rolling-element bearing comprising a stationary ring and a rotatable ring configured to rotate concentrically relative to one another and a plurality of rolling elements between a raceway of the stationary ring and a raceway of the rotatable ring, at least one of the rolling elements being a sensorized rolling element, the method comprising:
determining sets of machine operating measurements representative of an operation of the machine, each set of machine operating measurements being associated with a first reference moment and comprising a value indicative of an operating parameter of the machine,
determining sets of bearing operating measurements representative of an operation of the rolling-element bearing from measurements output by the sensorized rolling element, each set of bearing operating measurements being associated with a second reference moment,
determining sets of measurements, each set of measurement comprising a set of machine operating measurements wherein the first reference moment of the set of machine operating measurements is the same as the second reference moment of the set of bearing operating measurements,
determining values of at least one bearing indicator from the sets of bearing operating measurements according to the values of the operating parameter of the machine, the bearing indicator being a measured bearing indicator,
determining values of the bearing indicator from the simulation model of the machine and sets of machine operating measurements according to the values of the operating parameter of the machine, the bearing indicator being a simulated bearing indicator,
comparing the values of the measured bearing indicator and the simulated bearing indicator for identical values of the operating parameter of the machine, and
estimating an accuracy of the simulation model of the machine from the comparison.

2. The method to claim 1,
wherein determining the values of the at least one bearing indicator comprises:
binning the sets of measurements in a predetermined number of bins according to the values of the operating parameter of the machine, and
for each bin, determining a value of the bearing indicator from the sets of bearing operating measurements of the bin, the values of the measured bearing indicator being the values of the bearing indicator.

3. The method according to claim 2,
further comprising determining a first continuous function from the values of the bearing indicator of different bins, the measured bearing indicator being the first continuous function.

4. The method according to claim 2,
wherein determining the simulated bearing indicator comprises for each bin, implementing the simulation model a first time and a second time, wherein for each implementation of the simulation model, the inputs of the simulation model are machine operating measurements of a set of machine operating measurements, and determining for each implementation of the simulation model, at least a value of the bearing indicator from the output of the implementation of the simulation model, the values of the bearing indicator being the values of the simulated bearing indicator.

5. The method according to claim 1,
wherein comparing the values of the measured bearing indicator and the simulated bearing indicator and estimating the accuracy of the simulation model comprises:
determining a relative gap value between the values of the measured bearing indicator and the simulated bearing indicator for each value of the operating parameter of the machine,
determining a reference value from the plurality of relative gap values, the accuracy of the simulation model being equal to the reference value.

6. The method according to claim 5,
wherein the simulation model is determined to be sufficiently accurate if the reference value is less than a predetermined threshold.

7. The method according to claim 6,
wherein the machine is a wind turbine, and
wherein the sensorized rolling element comprises a load sensor, a position sensor and/or a speed sensor.

8. A device for estimating an accuracy of a simulation model of a machine, the machine comprising a rolling-element bearing, the rolling-element bearing comprising a stationary ring and a rotatable ring configured to rotate concentrically relative to one another and a plurality of rolling elements between a raceway of the stationary ring and a raceway of the rotatable ring, at least one of the rolling elements being a sensorized rolling element, the device comprising:
first determining means for determining sets of machine operating measurements representative of an operation of the machine, each set of machine operating measurements being associated with a first reference moment and comprising a value indicative of an operating parameter of the machine,
second determining means for determining sets of bearing operating measurements representative of an operation of the rolling-element bearing from measurements output by the sensorized rolling element, each set of bearing operating measurements being associated with a second reference moment,
third determining means for determining sets of measurements, each set of measurement comprising a set of machine operating measurements wherein the first reference moment of the set of machine operating measurements is the same as the second reference moment of the set of bearing operating measurements,
fourth determining means for determining values of at least one bearing indicator from the sets of bearing operating measurements according to the values of the operating parameter of the machine, the bearing indicator being a measured bearing indicator,
fifth determining means for determining values of the bearing indicator from the simulation model of the machine and sets of machine operating measurements according to values of the operating parameter of the machine, the bearing indicator being a simulated bearing indicator and
comparing means for comparing the values of the measured bearing indicator and the simulated bearing indicator for identical values of the operating parameter of the machine and estimating an accuracy of the simulation model of the machine from the comparison.

9. The device according to claim 8, wherein the sensorized rolling element comprise a load sensor, a position sensor and/or a speed sensor.

10. The device according to claim 9,
wherein the machine is a wind turbine.

11. A system for estimating an accuracy of a simulation model of a machine comprising a rolling-element bearing, the system comprising:
a device according to claim 9,
a machine comprising a rolling-element bearing, the rolling-element bearing comprising a stationary ring and a rotatable ring configured to rotate concentrically relative to one another, and a plurality of rolling elements between a raceway of the stationary ring and a raceway of the rotatable ring, and
a simulation model of the machine.

12. The system according to claim 11, wherein the machine is a wind turbine.

13. A system for estimating an accuracy of a simulation model of a machine comprising a rolling-element bearing, the system comprising:
a device according to claim 8,
a machine comprising a rolling-element bearing, the rolling-element bearing comprising a stationary ring and a rotatable ring configured to rotate concentrically relative to one another, and a plurality of rolling elements between a raceway of the stationary ring and a raceway of the rotatable ring, and
a simulation model of the machine.
